(19) United States
(12) Patent Application Publication
(10) Pub. No.: US 2014/0272423 A1
(43) Pub. Date: Sep. 18, 2014

(54) ANTI-CORROSION COMPOSITIONS FOR NATURAL GAS RECOVERY OR CONVEYING EQUIPMEN

(71) Applicant: Jacam Chemical Company 2013, LLC, Sterling, KS (US)

(72) Inventors: Gene H. Zaid, Sterling, KS (US); Gene F. Brock, Conroe, TX (US); Byron G. Owen, Sterling, KS (US); Harlan G. McCormack, Wichita, KS (US)

(73) Assignee: Jacam Chemical Company 2013, LLC, Sterling, KS (US)

(21) Appl. No.: 13/947,969

(22) Filed: Jul. 22, 2013

Related U.S. Application Data
(63) Continuation of application No. 13/803,082, filed on Mar. 14, 2013.

(51) Int. Cl. C09D 5/08

(52) U.S. Cl. CPC C09D 5/08
USPC 428/418; 523/453; 427/386

(57) ABSTRACT

Improved anti-corrosion systems are provided for use with hydrocarbon recovery, treatment and distribution equipment, in order to inhibit corrosion on the metal surfaces thereof. The systems include an epoxy resin, a curing agent for the resin, and a surfactant, which is the reaction product of an alkyl benzene sulfonic acid at least partially neutralized of from about 6-11 with an ammonia or amine neutralizing agent. The systems provide improved anti-corrosion protection in the case of metal surfaces not continually wetted with liquid hydrocarbons, such as crude oil.

### CROSS-REFERENCE TO RELATED APPLICATION

This is a continuation of identically-titled U.S. patent application Ser. No. 13/803,082, filed Mar. 14, 2013, which is incorporated herein by reference in its entirety.

### BACKGROUND OF THE INVENTION

1. Field of the Invention

The present invention is broadly concerned with improved anti-corrosion coating systems for application to metal surfaces exposed to hydrocarbons, in order to inhibit corrosion of the metal surfaces. More particularly, the invention is concerned with such coating systems, methods of use thereof, and finished metal objects having the cured coatings or films thereon, wherein the systems include an epoxy, a curing agent for the epoxy, and a surfactant, which is the reaction product of an alkylbenzene sulfonic acid and a neutralizing agent. The coating systems are particularly suited for application to metal surfaces which are only slightly wetted with liquid hydrocarbons, e.g., natural gas pipelines.

2. Description of the Prior Art

It is well known that oil and gas wells are subject to extensive corrosion. Downhole equipment such as sucker rods, pump rods, tubings and casings are generally made of mild steel which is adversely affected by the production fluid of the well. The often high temperatures and acidic nature of the production fluids and formation waters magnifies these corrosion problems. In addition, oil and gas pipelines and associated components are subject to similar corrosion problems.

A variety of anti-corrosion systems have been described in the past. Many corrosion inhibitors are aqueous dispersions containing a variety of components, e.g., 2-mercaptobenzothiozole, benzotriozole, tolyltriozole, phosphates, polyphosphates, organic soluble polymers, silicates, dithiocarbamates, nitrites, oxazoles, imidazoles, imidazolines, lignands, lignosulfates, tannins, phosphoric acid esters and boric acid esters. Many of these inhibitors are very prone to freezing during cold weather, making them very difficult to handle and maintain. Moreover, the useful life of many prior anti-corrosion treatments is very short, e.g., a week or less.

U.S. Pat. No. 4,526,813 describes composite systems made up of an epoxy resin, an alcohol and an amine curing agent such as N-tallow-1,3-diaminopropane. The tallow diamine curing agent in aromatic solvent has a tendency to freeze in cold weather conditions, necessitating the presence of the alcohol. In addition, the alcohol tends to inhibit agglomeration or clabbering which materially detracts from the utility of the anti-corrosion film.

U.S. Pat. No. 5,945,164 describes very successful coating systems for treating metal surfaces. These systems include an epoxy resin, a curing agent for the resin selected from the group consisting of alkoxylated amines and imidazolines, and mixtures thereof. While this systems of the '164 patent work exceedingly well on downhole oil well surfaces which are continually wetted with liquid hydrocarbons (i.e., crude oil), it has been found that they offer somewhat lesser degrees of protection in the case of natural gas pipelines or other equipment which is not continuously wetted with liquid hydrocarbon. In these instances, the coverage of the anti-corrosion systems on metal surfaces can be less than total, leaving patches or areas of the metal surfaces unprotected.

### SUMMARY OF THE INVENTION

The present invention overcomes the problems outlined above, and provides improved anti-corrosion systems, which can be effectively used in all cases where metal surfaces are exposed to the corrosive effects of crude hydrocarbons, even in instances where the metal surfaces are not fully wetted with liquid hydrocarbons.

Generally speaking, the corrosion systems of the invention include an epoxy resin, such as glycidyl ethers prepared by the reaction of epichlorohydrin with bisphenol A, together with a suitable curing agent, such as an alkoxylated amine or an imidazoline. The systems further include one or more specialized surfactants, which are the reaction products of an alkylbenzene sulfonic acid and a neutralizing agent, such as ammonia, the morpholine alkylamines, the primary, secondary, and tertiary cyclohexylamines, the alkanolamines, the alkylene amines, and mixtures thereof. The combination of these components provides full and effective coverage on all types of metallic surfaces, including those not continuously wetted with liquid hydrocarbons. In preferred forms, the curing agent is imidazoline and the surfactant is the reaction product of dodecylbenzene sulfonic acid and primary cyclohexylamine having a pH of from about 9-11.

In use, the components of the anti-corrosion systems may be sequentially applied to metal surfaces, or the components may be pre-mixed and applied as a single dispersion. After the systems cure, a protective, anti-corrosive coating forms on the metal surfaces.

### DETAILED DESCRIPTION OF THE PREFERRED EMBODIMENT

In the following discussion, the individual components of the anti-corrosion systems will be respectively described as Components A-D, and thereafter the complete systems are described together with uses thereof.

### Component A—Epoxy

A variety of epoxies can be used in the invention. Generally, any epoxy resin having, on the average, more than one vicinal epoxy group per molecule can be used in the composition and process of the invention. The epoxy resin may be saturated or unsaturated, aliphatic, cycloaliphatic, aromatic or heterocyclic, and may bear substituents which do not materially interfere with the curing reaction.

Suitable epoxy resins include glycidyl ethers prepared by the reaction of epichlorohydrin with a compound containing a hydroxyl group (e.g., bisphenol A) carried out under alkylene reaction conditions. Other suitable epoxy resins can be prepared by the reaction of epichlorohydrin which mononuclear di- and tri-hydroxy phenolic compounds such as resorcinol and phloroglucinol, selected polynuclear polyhydroxy phenolic compounds such as bis(p-hydroxyphenyl)methane and 4,4′-dihydroxy biphenyl, or aliphatic polyols such as 1,4-butanediol and glycerol.

Epoxy resins suitable for use in the invention have molecular weights generally within the range of 50 to about 10,000, preferably about 200 to about 2000. The commercially available Epon 828 epoxy resin, a reaction product of epichlorohydrin and 2,2-bis(4-hydroxyphenyl)propane (bisphenol A) and having a molecular weight of about 400, an epoxide equivalent (ASTM D-1652) of about 185-192, is presently preferred.

Additional epoxy-containing materials suitable for use in the present invention include the epoxidized derivatives of natural oils such as the triesters of glycerol with mixed long-chain saturated and unsaturated acids which contain, e.g., 16, 18 and 20 carbon atoms. Soybean oil is a typical triglyceride which can be converted to a polyepoxide suitable for use in the instant invention.

Other polyepoxides suitable for use in the present invention are derived from esters of polycarboxylic acids such as maleic acid, terephthalic acid, oxalic acid, succinic acid, azelaic acid, malonic acid, tartaric acid, adipic acid and the like, with unsaturated alcohols.

In addition to the foregoing, it is contemplated that suitable polyepoxides can be derived from esters prepared from unsaturated alcohols and unsaturated carboxylic acids. Representative epoxidized esters include the following: 2,3-epoxypentyl-3,4-epoxybutyrate; 2,3-epoxybutyl-3,4-epoxyhexanoate; 3,4-epoxyoctyl-2,3-epoxycyclohexane carboxylate; 2,3-epoxydodecyl-4,5-epoxyoctanoate; 2,3-epoxyisobutyl-4,5-epoxydodecanoate; 2,3-epoxycyclododedcyl-3,4-epoxypentanoate; 3,4-epoxyoctyl-2,3-epoxycyclododecane carboxylate and the like.

Other unsaturated materials which can be epoxidized to give resins suitable for use include butadiene based polymers such as butadiene-styrene copolymers, polyesters available as derivatives of polyols such as ethylene glycol with unsaturated acid anhydrides such as maleic anhydride and esters of unsaturated polycarboxylic acids. Representative polyepoxides derived from the latter include the following: dimethyl 3,4,7,8-diepoxydecanedioate; dibutyl 3,4,5,6-diepoxycyclohexane-1,2-carboxylate; dioctyl 3,4,7,8-diepoxyhexadecanedioate; diethyl 5,6,9,10-diepoxytetradecanedioate and the like.

Dimers of dienes such as 4-vinyl cyclohexene-1 from butadiene and dicyclopentadiene from cyclopentadiene can be converted to epoxidized derivatives which are suitable for use.

### Component B—Curing Agent

The alkoxylated amine curing agents useful in the invention may be aliphatic, cycloaliphatic, aromatic or heterocyclic. Particularly preferred are the alkoxylated polyamines, especially the alkoxylated N-alkyl- and N-alkylenyl-substituted 1,3-diaminopropanes and mixtures thereof. Examples of such alkoxylated polyamines include alkoxylated N-hexadecyl-1,3-diaminopropane, N-tetradecyl-1,3-diaminopropane, N-octadecyl-1,3-diaminopropane, N-pentadecyl-1,3-diaminopropane, N-heptadecyl-1,3-diaminopropane, N-nonadecyl-1,3-diaminopropane, and N-octadecenyl-1,3-diaminopropane. Various commercially available mixtures of ethoxylated N-alkylated and N-alkenylated diamines can be used in the invention. The presently preferred polyamine is a commercial product, ethoxylated N-tallow-1,3-diaminopropane, where the degree of ethoxylation is approximately 10 moles ethoxylate per mole of tallow diamine.

Various imidazoline derivatives can be employed in the invention and the most preferred derivatives are set forth in the following structural formula:

[chemical structure]

wherein R₁ is hydrogen or an alkyl group having up to 18 carbon atoms therein, and R₂ is hydrogen, or an alkyl or amine group having up to 18 carbon atoms therein. A suitable imidazoline may be prepared as a reaction product of diethylene triamine and tall oil fatty acid. The single most preferred imidazoline is that manufactured and sold by JaCam Chemicals, LLC of Sterling, Kans., under the designation JC 2090.

### Component C—Alkyl Benezene Sulfonic Acid

This component includes compounds of the formula:

[chemical structure]

wherein R₃ and R₄ are each straight or branched chain alkyl groups of varying chain lengths, and wherein R₃+R₄ ranges from 8-24, including all isomeric forms thereof. The most preferred compound is dodecylbenzyl sulfonic acid, where R₃+R₄ is 11. Preferably, for reasons of biodegradability, the sulfonic acids are linear, meaning that the R₃ and R₄ are unbranched.

### Component D—Neutralizing Agent

As noted above, in order to create the complete surfactant, the alkyl benzyl sulfonic acid is reacted with a neutralizing agent to give a pH of from about 6-11. The neutralizing agent is selected from the group consisting of ammonia, the morpholene alkyl amines, the primary, secondary, and tertiary cyclohexylamines, the alkanolamines, the alkylene amines, and mixtures thereof.

The morpholene alkyl amines preferably have C2-C10 straight or branched chain alkyl group(s), with the most preferred agent being morpholene isopropylamine. The cyclohexylamines may be primary, where the amine moiety is —NH₂, or secondary or tertiary amines, where the amine moiety would be substituted with one or two C1-C6 alkyl groups. The alkanolamines normally have C1-C6 alkanol moieties, most preferably C2 (e.g., monoethanolamine and diethanolamine). The alkylene amines may be mono-, di-, or triamines, and are most preferably ethylene diamine and diethylene triamine.

The reaction between the neutralizing agent(s) and the alkylbenzene sulfonic acid is carried out at room temperature with sufficient neutralizing agent being present to achieve a final pH of from about 6-11, more preferably from about 9-10. The degree of neutralization of the sulfonic acid component determines the solubility of the final surfactant in oil and water. The final surfactant is usually an anionic surfactant.

### Complete Coating Systems

Generally speaking, the systems of the invention include one part by weight of epoxy, with from about 1-6 (more preferably about 2-4) parts by weight of curing agent per each part of epoxy, and from about 0.1-2 (more preferably from about 0.2-0.6) parts by weight of surfactant per each part of epoxy.

The single most preferred coating system in accordance with the invention contains one part by weight of Epon 828 epoxy resin, about three parts by weight of imidazoline curing agent per each part of epoxy resin, and about one-third part by weight of an anionic surfactant having a pH of from about 9-10 per each part of epoxy resin, wherein the surfactant is the reaction product of dodecylbenzene sulfonic acid and primary cyclohexylamine.

In preferred systems of the invention, the epoxy resin is advantageously dispersed in an aromatic liquid dispersant, preferably selected from the group consisting of benzene, xylene, toluene, heavy aromatic napthas, and mixtures thereof. In like manner, the curing agent and surfactant are also dispersed in such aromatic dispersants. Thus, there may be three dispersions respectively including the epoxy, curing agent, and surfactant, in the same or different aromatic dispersants. However, if desired, the surfactant and curing agent may be dispersed in a single aromatic dispersant, because these components do not substantially react. It is also possible to mix together the epoxy, curing agent, and surfactant in a single dispersion, but owing to the relatively rapid reaction between the epoxy and curing agent, this should only be done if the system is to be relatively immediately applied to metal surfaces. The concentration of active ingredient within the dispersions is variable and not critical, but typically the dispersions have from about 10-50% by weight of the active ingredient therein, depending upon the dispersibility of the active ingredient and the nature of the dispersant.

In order to apply the coating systems to metal surfaces, the components thereof may be applied sequentially, i.e., an initial application of the epoxy, followed by application of the curing agent and surfactant; more usually, the epoxy is first applied, followed by a mixture of the curing agent and surfactant. Alternately, the epoxy, curing agent, and surfactants can be dispersed in water and the dispersion applied in a pipeline, downhole, or on the metal surfaces of equipment such as tanks.

The components in whatever combinations may be applied by any convenient technique, so long as the metal surfaces of interest are effectively coated. For example, in the case of virgin oil or gas pipelines, or reconstructed versions thereof, the components may be painted or sprayed onto the inner metallic surfaces. Downhole metal surfaces, such as those of oil well casings, sucker rods, pump rods, and associated equipment, can be treated by the same means, or by injecting the components of the systems without stopping the production of the well. Thereafter, the downhole surfaces are flushed with formation water for a period of time sufficient to ensure that the coating system is properly applied. The time of formation water flushing can be estimated by a preliminary test involving injection of a dye into the circulating well fluid and noting the time between injection and appearance of the dye at the well head.

Where the system components are applied by painting or spraying, the final cured coatings typically have a thickness of from about 5-50 mils, more preferably from about 15-25 mils. The curing time in such instances is typically 6-8 hours. When the systems are applied to operating downhole or pipeline equipment during operation thereof, the formed coatings are thinner, typically having a thickness of 0.5-5 mils, more preferably from about 2-3 mils.

The most preferred coating system of the invention was tested by coating a ¾-inch×3-inch flat coupon of 1018 cold-rolled carbon steel, and allowed to dry thereon. The coated coupon was then immersed in a 10% copper sulfate solution for 30 seconds. The coated coupon was then removed and inspected for copper color and deposition on the coupon surface. No discolorations were noted, thereby confirming that an effective anti-corrosion layer existed on the coupon. An untreated coupon was similarly tested, and, after immersion in the copper sulfate solution, was completely copper-coated.

The invention thus provides, on metallic surfaces of equipment subject to contact with oil or gas hydrocarbons, an effective anti-corrosive coating which provides full coverage even in situations where the metallic surfaces are not continuously wetted with liquid hydrocarbons.

1. An anti-corrosion coating system comprising:
an epoxy;
a curing agent for the epoxy and selected from the group consisting of an alkoxylated amine and an imidazoline, and mixtures thereof; and
a surfactant comprising the reaction product of an alkylbenzene sulfonic acid and a neutralizing agent selected from the group consisting of ammonia, a morpholine alkyl amine, a cyclohexylamine, an alkanolamine, an alkylene amine, and mixtures thereof, said reaction product having a pH of from about 6-11,
said reaction product being present at a level of from about 0.2-2 parts by weight per each part by weight of said epoxy,
said epoxy, curing agent, and surfactant after curing thereof giving a corrosion-resistant coating for metal surfaces otherwise exposed to the corrosive effects of crude hydrocarbons, even in instances where such metal surfaces are not fully wetted with liquid hydrocarbons.

2. The system of claim 1, said epoxy, curing agent, and surfactant each dispersed in an individual aromatic dispersant.

3. The system of claim 2, each of said dispersants individually selected from the group consisting of benzene, xylene, toluene, heavy aromatic napthas, and mixtures thereof.

4. The system of claim 1, said curing agent being an alkoxylated tallow amine having from about 2-15 moles of alkoxylate per mole of tallow amine.

5. The system of claim 4, said curing agent having from about 3-10 moles of alkoxylate per mole of tallow amine.

6. The system of claim 4, said curing agent being an ethoxylated tallow amine.

7. The system of claim 4, said curing agent being an alkoxylated tallow diamine.

8. The system of claim 1, said curing agent being an imidazoline having the formula: [chemical structure]
wherein R1 is hydrogen or an alkyl group having up to 18 carbon atoms therein, and R2 is hydrogen, or an alkyl or amine group having up to 18 carbon atoms therein.

9. The system of claim 8, said imidazoline being the reaction product of diethylene triamine and tall oil fatty acid.

10. The system of claim 1, the ratio of said curing agent to said epoxy being from about 1-6 parts by weight curing agent for each part by weight epoxy.

11. (canceled)

12. (canceled)

13. The system of claim 1, said surfactant comprising dodecylbenzene sulfonic acid at least partially neutralized by reaction with primary cyclohexylamine.

14. The system of claim 1, said surfactant being mixed with said curing agent.

15. The system of claim 1, said epoxy, curing agent, and surfactant being mixed together at the point of use thereof, and thereafter applied.

16. A method of treating metal surfaces which come into contact with hydrocarbons to inhibit corrosion of the metal surfaces, said method comprising the steps of:
applying an anti-corrosion system to said metal surface, said system including
an epoxy;
a curing agent for the epoxy and selected from the group consisting of an alkoxylated amine and an imidazoline, and mixtures thereof;
a surfactant comprising the reaction product of an alkylbenzene sulfonic acid and a neutralizing agent selected from the group consisting of ammonia, a morpholine alkyl amine, a cyclohexylamine, an alkanolamine, an alkylene amine, and mixtures thereof, said reaction product having a pH of from about 6-11,
said reaction product being present at a level of from about 0.2-2 parts by weight per each part by weight of said epoxy; and
applying said system to said metal surface, and causing said epoxy to react with said curing agent to form a cured coating on the metal surface, said coating protecting said metal surface from the corrosive effects of crude hydrocarbons, even in instances where such metal surfaces are not fully wetted with liquid hydrocarbons
said coating having a thickness of from about 0.5-50 mils.

17. The method of claim 16, including the step of first applying said epoxy to said metal surfaces, and thereafter applying said curing agent and surfactant to the metal surfaces pre-coated with said epoxy.

18. The method of claim 16, including the steps of first mixing together said epoxy, curing agent, and surfactant, and thereafter applying the mixture to said metal surfaces.

19. Equipment having metallic surfaces subject to the corrosive effects of crude hydrocarbons including a coating comprising the cured residue of an anti-corrosion system, comprising:
an epoxy;
a curing agent for the epoxy and selected from the group consisting of an alkoxylated amine and an imidazoline, and mixtures thereof; and
a surfactant comprising the reaction product of an alkylbenzene sulfonic acid and a neutralizing agent selected from the group consisting of ammonia, a morpholine alkyl amine, a cyclohexylamine, an alkanolamine, an alkylene amine, and mixtures thereof, said reaction product having a pH of from about 6-11,
said reaction product being present at a level of from about 0.2-2 parts by weight per each part by weight of said epoxy,
said epoxy, curing agent, and surfactant giving a corrosion-resistant coating on said metal surfaces, even in instances where such metal surfaces are not fully wetted with liquid hydrocarbons
said coating having a thickness of from about 0.5-50 mils.

20. The equipment of claim 19, said equipment being a part of oil or gas recovery or transmission structures.

21. The system of claim 1, said surfactant comprising the reaction production of dodecylbenzene sulfonic acid and primary cyclohexylamine having a pH of from about 9-11.

22. The system of claim 1, said reaction product being present at a level of from about 0.2-0.6 parts by weight per each part by weight of said epoxy.
